(19) United States
(12) Patent Application Publication
(10) Pub. No.: US 2014/0341440 A1
(43) Pub. Date: Nov. 20, 2014

(54) IDENTITY CADDY: A TOOL FOR REAL-TIME DETERMINATION OF IDENTITY IN THE MOBILE ENVIRONMENT

(71) Applicant: Mark A. Walch, Fairfax Station, CA (US)

(72) Inventor: Mark A. Walch, Fairfax Station, CA (US)

(21) Appl. No.: 14/251,492

(22) Filed: Aug. 4, 2014

Related U.S. Application Data
(60) Provisional application No. 61/811,661, filed on Apr. 12, 2013.

(51) Int. Cl. G06K 9/00

(52) U.S. Cl. CPC G06K 9/00892; G06K 9/00087; G06K 9/00288; G06K 9/00268; G06K 9/00617
USPC 382/116; 382/115; 382/124

(57) ABSTRACT

Identity caddy for real-time determination of identity in the mobile environment. The identity caddy offers a means for expanding protection beyond what a password can provide by establishing actual identity through biometric features and behavior characteristics. Furthermore, identity is established from multiple sources (including biometrics as well as locational and environmental factors), and once the identify caddy obtains this information, it corroborates identity by considering them all in tandem through fusion. In an aspect, identity is built from several measures, including biometric features as well as non-biometric features, such as location and travel patterns. Melding identity with portable devices opens the door to numerous new applications for transaction and access controls rooted in identity and supporting commerce, as well as many forms of physical and cyber-security.

### BACKGROUND OF THE INVENTION

The present invention is directed generally to the field of biometrics (identifying persons using multiple physical features such as fingerprint, face, iris, voice, handwriting and signature, gait and the like) coupled with activities of everyday life (such as geographic location, travel patterns, proximity to certain computer networks, etc.).

### BRIEF SUMMARY OF THE INVENTION

This invention is referenced as the “Identity Caddy” and takes the form of a software-based solution that resides on smartphones and other portable devices. The Identity Caddy performs two principal functions: (1) providing an ongoing real-time assessment of the identity of the individual possessing a smartphone or similar device and (2) providing a “portal” for “on the fly” identity verification in support of e-commerce, entry access for both physical and cyber-security as well as other venues where confirmation of identity is essential. The purpose of the Identity Caddy is to provide identity verification capability in a way that is neither unobtrusive to the user of the device or requires only minimal overt actions by the user. The Identity Caddy persistently operates in the “background” on the device where installed and when user interaction is necessary, it presents the look and feel of “one touch” identity verification. The Identity Caddy is a personal “Key FOB” designed to eliminate passwords without burdening the user.

### BRIEF DESCRIPTION OF THE DRAWINGS

The embodiments are described with the aid of the drawings of which:

FIG. 1 is a table that illustrates some biometrics that can be captured using a conventional smartphone, and providing data to the Identity Caddy, according to an embodiment;

FIG. 2 illustrates images that provide an overview of a ridge-based method that can be employed on a smartphone to capture fingerprints through the camera, according to an embodiment;

FIGS. 3A and 3B illustrate an image of a set of fingers captured through a smartphone and how these images can be transformed into a high-contrast image, further illustrating the barcode concept, according to an embodiment;

FIG. 4 illustrates how the Identity Caddy can couple the image of the face with multiple sensor information to establish a gaze angle for the face, according to an embodiment;

FIG. 5 illustrates an ear with a graph overlay that can be interpreted by a computer like a barcode, according to an embodiment;

FIG. 6A illustrates a schematic overview of the EVM algorithm, according to an embodiment;

FIG. 6B illustrates a face segmented into zones, according to an embodiment;

FIG. 7 some points on the face associated with speaking, according to an embodiment;

FIG. 8 illustrates a technique for analyzing waveforms by triangulating the raw or filtered data and calculating hash keys for embedded isomorphisms from the triangulations, according to an embodiment;

FIG. 9 illustrates raw data produced by a smartphone accelerometer, according to an embodiment;

FIG. 10 illustrates a sample map wherein certain sectors have been shaded in darkening dot patterns, according to an embodiment;

FIGS. 11-13 illustrate examples of biometric functionality that utilize existing sensors, according to embodiments;

FIG. 14 illustrates the Identity Caddy establishing an identity using facial features, according to an embodiment;

FIG. 15 illustrates a schematic of a smartphone, identifying several sensors and related devices, according to an embodiment;

FIG. 16 illustrates a scenario supporting the use of a device as a means for confirming identity for an online transaction performed on another device, according to an embodiment; and

FIGS. 17A-17B illustrate a high-level schematic flow of identity corroboration using the Identity Caddy, according to an embodiment.

### DETAILED DESCRIPTION OF THE INVENTION

The most commonly used means for controlling access, particularly in the cyber world, is the password. The Identity Caddy offers a means for expanding protection beyond what a password can provide by establishing actual identity through biometric features and behavior characteristics. Furthermore, identity is established from multiple sources (including biometrics as well as locational and environmental factors) and once the Identity Caddy obtains this information it corroborates identity by considering them all in tandem through fusion. A critical aspect of this invention is that identity is built from several measures including biometric features as well as non-biometric features such as location and travel patters. Melding identity with portable devices opens the door to numerous new applications for transaction and access control rooted in identity and supporting commerce as well as many forms of physical and cyber-security.

The Identity Caddy offers a viable alternative to not only to the password but it also presents an alternative to many other forms of access control including “traditional” biometrics identification methods such as incorporating a fingerprint scanner within a mobile device. The problem with passwords and embedded biometric devices (such as fingerprint and iris scanners) is they are either cumbersome or can be “cracked” by experts. The Identity Caddy provides an alternative to passwords and traditional biometrics by empowering portable devices such as smartphones to establish the identity of users on a real-time basis. Key to the Identity Caddy is bundling identification capability with existing sensors on cellular hardware, including: (1) digital cameras (forward and rear facing) for still and video images, (2) microphone, (3) touch display sensor, (4) accelerometer, (5) gyroscope, (6) distance detector, (7) GPS, (8) clock, (9) compass and (10) network connectivity. Through the Identity Caddy, each sensor provides a glimpse of identity.

Using these sensors as its primary inputs, the Identity Caddy establishes the identity of the phone's user through “Visible” and “Unobtrusive” biometric analysis. That is, the Identity Caddy will take some actions that prompt the user for identity information (Visible) while performing other forms of analysis as background activities of which the user will not be aware (Unobtrusive). For Visible biometric analysis, the Identity Caddy will prompt the user to provide biometric information such as a facial image, a voice clip or a fingerprint. For Unobtrusive biometrics, personal identity is established by monitoring routine interaction between the user and the device, with no overt action or change in behavior by the user to establish identity. The Identity Caddy constantly and automatically monitors the sensors on an ongoing basis to determine or confirm user identity.

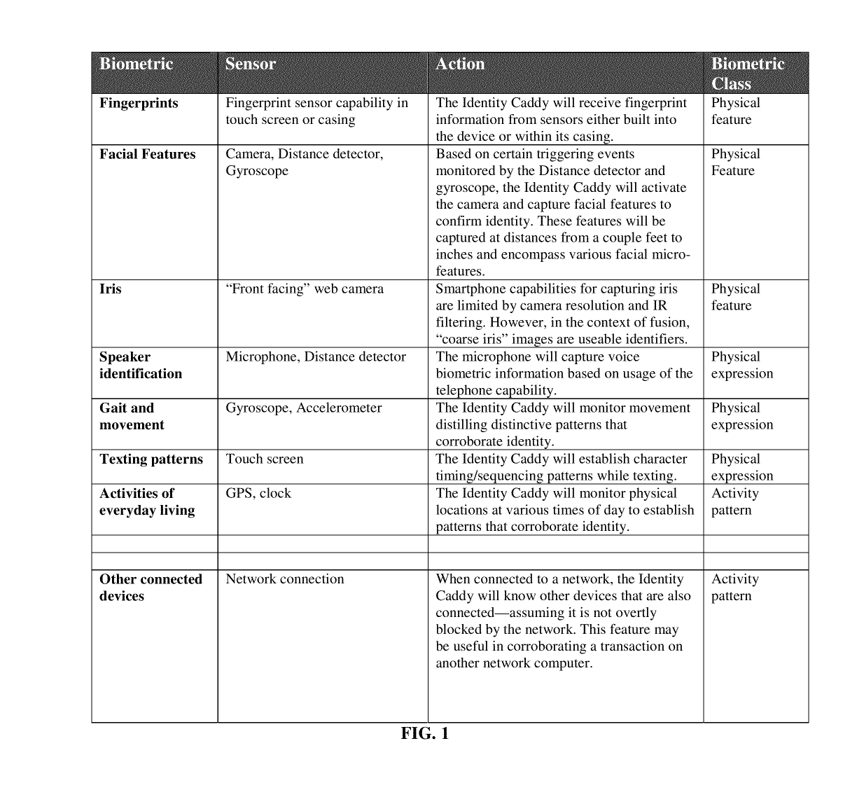

FIG. 1 illustrates some Biometrics that can be captured a conventional smartphone providing data to the Identity Caddy. The first column in this table lists the various identity-related features that can be captured through the mobile device. The second column identifies the particular sensors available on the device to capture the information shown in the first column. The third column describes the action taken to establish identity. All sensors identified are currently available in modern smartphones.

The biometric modalities used by the Identity Caddy—whether Visible or Unobtrusive—fall into three categories: (1) physical characteristics, (2) physical expressions and (3) activity patterns. Physical characteristics are direct physiological features such as a fingerprint or the pattern of an iris. Physical expressions are the actions that are influenced by these physical characteristics such a speech patterns or gait. The third category, Activity Patterns, can otherwise be considered the activities of daily living and include where a person travels, how they travel there, how long they stay, when they travel and the like.

Attendant to each modality whether biometric or behavioral, Identity Caddy draws upon a method to extract identity data and to generate a verification score from these data. These scores provide a measure of likelihood the identity “specimen” came from the person authorized to use the smartphone. Because each modality works with limited data, fusion is used to aggregate identification from multiple modalities to increase verification power. In particular, when the separate modalities are unable to put the true subject into the best rank due to poor quantity and quality of sample data, the fused score becomes very important for assembling sufficient data to ensure the true subject of the verification is properly matched. In the Identity Caddy, fused scores are produced for all three categories of identity: (1) physical characteristics, (2) physical expressions and (3) activity patterns each composed of individual identity measures within the respective categories.

Using the fused identity score, the Identity Caddy generates an overall assessment of the likelihood the possessor of the smartphone is its authorized. This approach is conceptually credit scoring is derived using the “FICO method”. However, the Identity Caddy is designed to keep the actual scoring formula secret as well as robust and determinable by proprietary methods. That is, the Identity Caddy will provide the “raw material” for scoring in the form of identities depicted in terms of statistical likelihoods. The actual formula for using these values remains flexible and can be proprietary. Also, aside from the information derived from the Unobtrusive biometrics that underlie the identity risk scoring, the Identity Caddy also offers the ability for ad hoc biometric data capture by seeking biometrics “on the fly”. For example, if the score derived from the Unobtrusive biometrics falls short of an acceptance threshold for confirming identity, the Identity Caddy can prompt the user to speak, touch a sensor or look into the camera as a couple examples of visible biometrics. The logic for seeking these biometrics can be randomized to deter any organized plan for biometric “spoofing”. The “threshold” is a parameter that can be specified given the security of the transaction. For instance, for a relatively unsecured transaction, knowing the person is in a location they frequent may be enough. On the other hand, some transactions may be so important that it is necessary to obtain a real-time biometric collection from the individual possessing the device.

FIG. 1 presents sensors available in a conventional smartphone and their respective identity contributions which are further discussed through the ensuing paragraphs. Each individual biometric and behavioral measure reference a particular approach that could be applied to establish identity through biometrics or behavior. It should be noted that there exist multiple viable approaches for identifying individuals through biometric and behavioral data and the Identity Caddy is “agnostic” regarding the specific implementations for the individual identity measures which should be viewed as “plug-ins” within the Identity Caddy platform. There are many existing proven biometrics which will continue to improve as well as new measures of identity that will be discovered. The Identity Caddy will be sufficiently robust to incorporate new and improved identity measures as they become available.

The following paragraphs provide a narrative description of the major biometric and behavioral measures to be incorporated in the Identity Caddy. These are listed as: (1) Fingerprint, (2) Face and Facial Features, (3) Dynamic Skin Coloration, (4) Iris Recognition, (5) Speaker Identification, (6) Gait and Motion Dynamics, and (7) Activities of Daily Living.

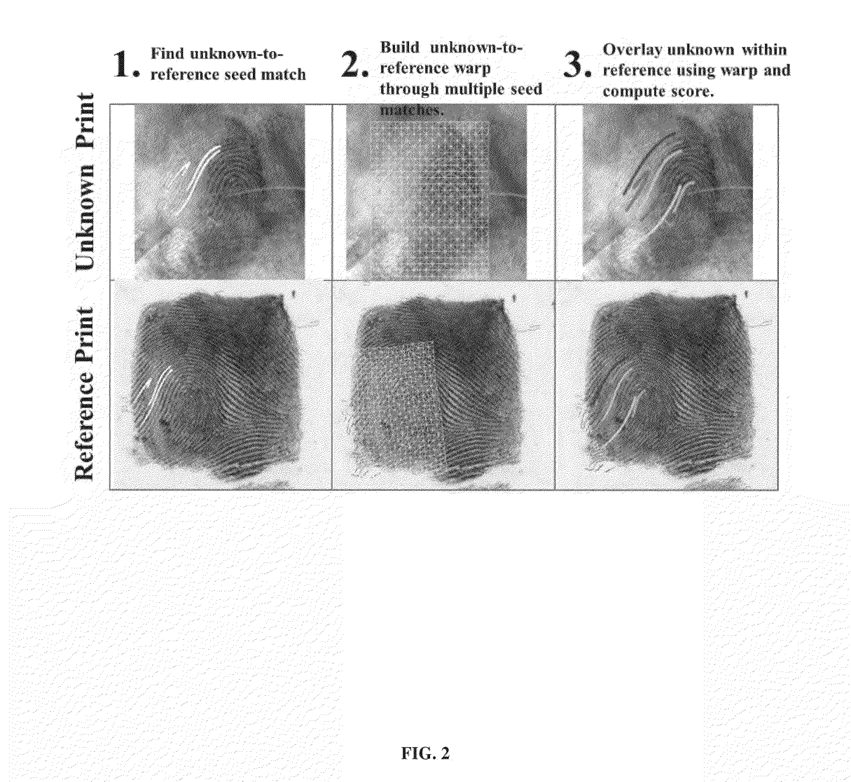

Discussion of Fingerprints: Even after the introduction of DNA, fingerprints still remain a very important biometric of identity. The ridges and furrows in human fingerprints effectively create a “barcode” of identity. The Identity Caddy incorporates various fingerprint identification methods including “traditional” methods which rely on minutiae as well as methods that can work in the absence of minutiae by using the ridges and furrows to treat the fingerprint like a barcode. This latter barcode-like method opens the use of the camera as a fingerprint sensing device. FIG. 2 provides an overview of a ridge-based method that can be employed on a smartphone to capture fingerprints through the camera.

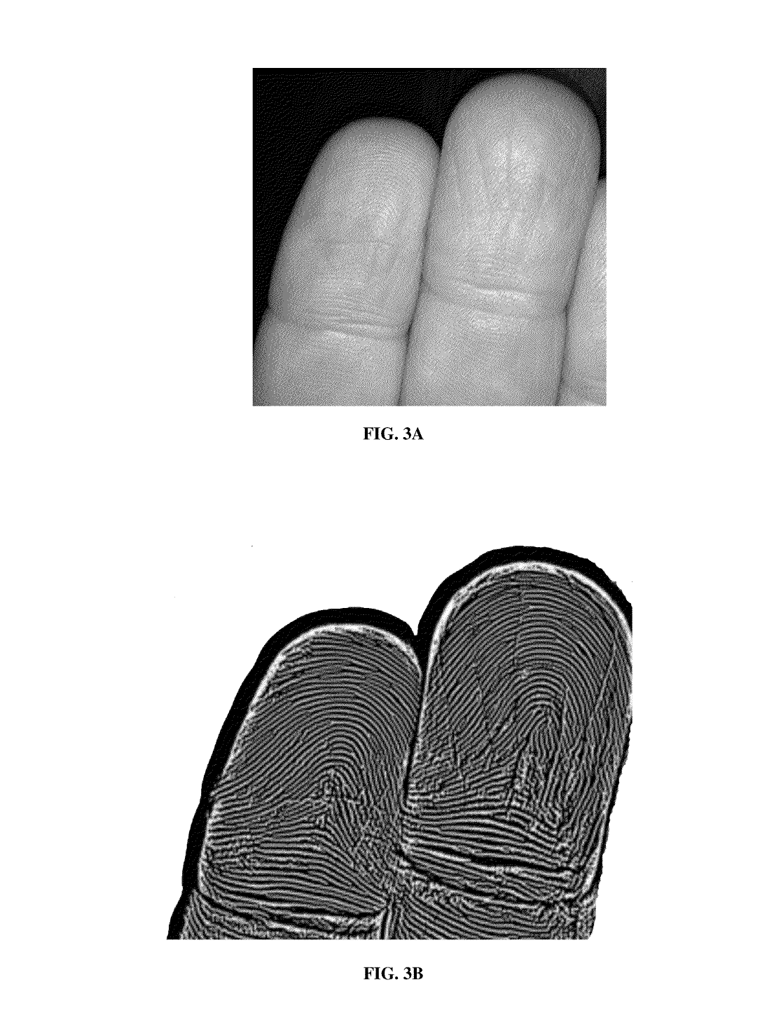

The method illustrated in FIG. 2 is capable of matching fingerprints based on ridge-flow instead of traditional minutiae points (minutiae points are places where the ridges either bifurcate or end). Using ridges instead of minutiae creates the opportunity to capture identity from smaller sections of the print (such as the tip or side) that may lack sufficient minutiae for conventional matching. This capability is important to the Identity Caddy since fingerprints may be captured unobtrusively revealing only portions of the print. Using the method illustrated in FIG. 2, the Identity Caddy can find useful identity information even though the view of the print is limited. In this ridge-centric method, Bezier approximations of ridge curvature are used as Ridge Specific Markers. Control points arising from Bezier curves generate unique polygons that represent the actual curve in the fingerprint. In FIG. 2, the top row shows how the match process works on an unknown print and the bottom row shows the corresponding activities with a known reference print. The first column (FIG. 2) indicates groups of curves with similar individual curvature and relationships among the curves are detected between prints. As these curves are detected, a “warp” is determined to account for the deformation of skin due to its elasticity. This warp is shown in the second column (FIG. 2). Finally, once a full warp has been calculated based on multiple individual curve matching, the unknown print is fitted to the know reference print and a score calculated. This fitting is illustrated in column 3 (FIG. 2). Effectively, this method treats fingerprints and fingerprint fragments as barcodes which is a highly machine readable format. FIG. 3a shows an image of a set of fingers captured through a smartphone. FIG. 3b shows these images transformed into a high contrast image further illustrating the barcode concept.

Face and Facial Feature Identification (including ear): Face recognition is the principal way people recognize each other. As such, Face identification is one of the biometric identification techniques well poised for broad implementation. The principal difficulties with Facial Recognition are that—compared to other biometrics—the number of features presented by the face is relatively few and the character of the features can change given variations in the conditions under which they are observed. Faces are 3 dimensional objects and the features they exhibit are very much related to the position from which the face is observed and influenced by many other factors. In addition to gaze (viewing vantage angle), other issues that affect face are aging, illumination, expression, resolution (distance) and occlusion.

The Identity Caddy is capable of capturing faces from various “poses”. For instance, the smartphone can capture a direct picture of a face as an individual looks at the phone's screen display. Also, the camera can capture pictures of the facial portrait (including ear) as a person speaks into the smartphone. The distance detector on the display side of the phone can be used to provide precise measurements to the face and instruct the phone a person is moving the device towards the ear. And, the gyroscope and accelerometer can compute gaze angle of the face and position of the camera relative to the face.

Gaze angle offers a way to normalize all facial views and improve recognition. Calculating the gaze angle of the subject provides one means of eliminating variability due to pose which will help overcome difficulties caused by low resolution. Furthermore, the gaze angle offers a measure that can be calculated directly from the information contained in the image. Establishing the gaze angle takes two steps.

Step 1: The eyes are located within the image containing an individual of interest. In conjunction with the eyes, a “third” reference point is established based on the nose.

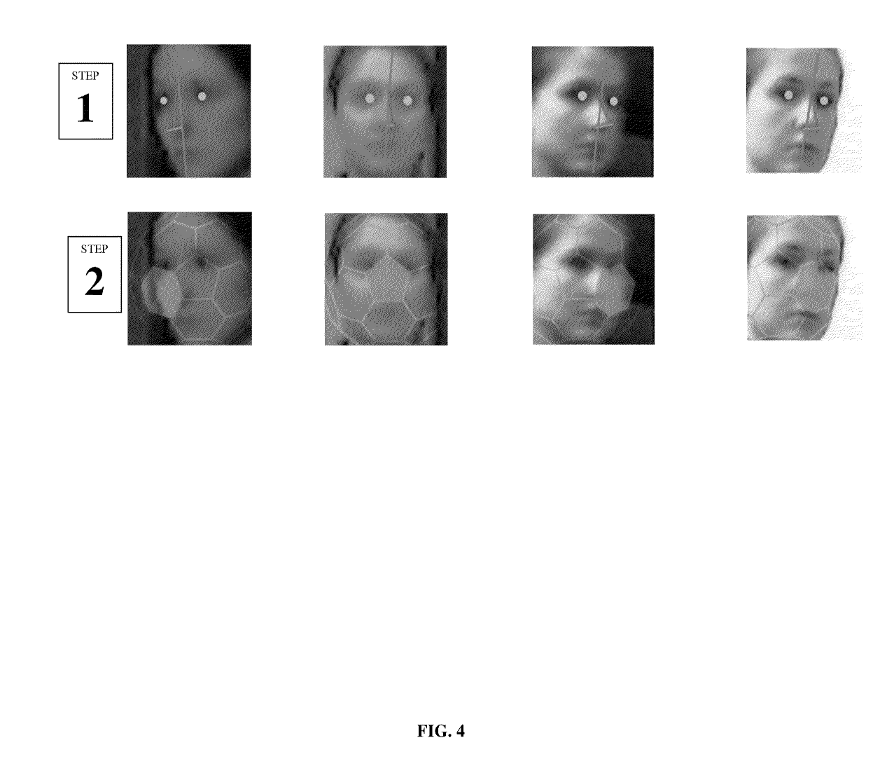

Step 2: The eyes and nose support the calculation of a gaze angle. These angles are stored in a data structure conceptually similar to a truncated icosahedron (“Bucky Ball”). FIG. 4 illustrates how the Identity Caddy can couple the image of the face with multiple sensor information to establish a gaze angle for the face.

The unique ability of the Identity Caddy to improve facial recognition by combining data from other smartphone-based sensors enables it to incorporate off-the-shelf facial recognition technology and improve the recognition results leading to better determination of identity.

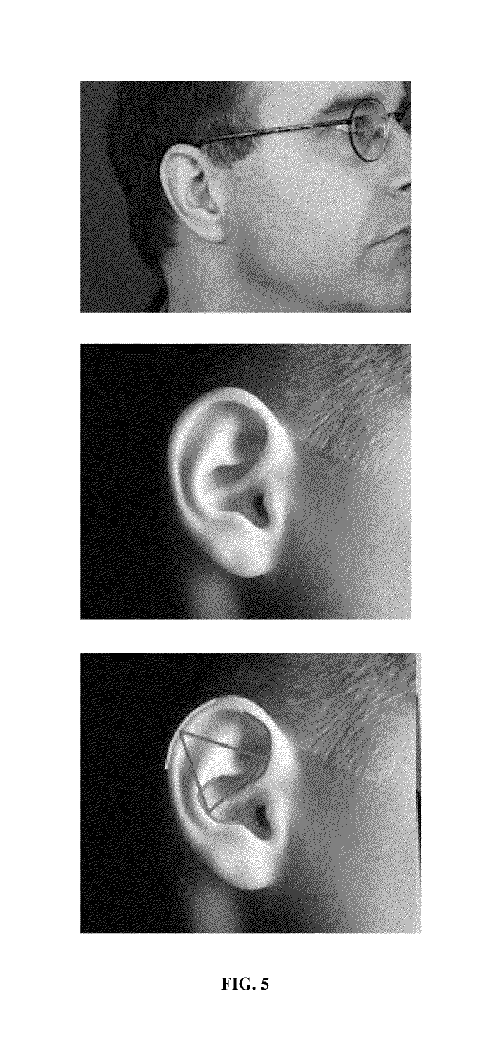

Because of their distinctive structures, ears provide excellent biometric identifiers that can be captured in an unobtrusive manner in real time. The ridge structure in ears also gives them characteristics similar to barcodes. FIG. 5 shows an ear with a graph overlay that can be interpreted by a computer like a barcode. The ear can be identified in a manner similar to the ridge-based fingerprint matching previously discussed.

Also, facial identification need not focus on the entire face. The “ocular region” (the area surrounding the eyes) is the most stable version of the frontal face and may in itself be sufficient for identity verification. However, this area is also susceptible to occlusion from glasses. In any case, using the fusion of multiple sensor data as herein discussed, the Identity Caddy can locate and normalize the ocular region view applying both facial recognition and iris recognition techniques to this area.

Dynamic skin coloration: Related to the face is the ability to identify an individual by subtle changes in skin color related to blood flow. The Identity Caddy can draw upon an image processing technology called Eulerian Video Magnification (EVM), which essentially tracks the variation of individual pixels over time—and then exaggerates those differences. As an example, as a heart pumps blood arteries will enlarge with bright red blood, which changes the skin color slightly. This change is invisible to the human eye but can be measured in video imagery available through the smartphone camera. This technique was originally developed the software to measure the vital signs of neonatal babies without physical contact, but it also opens the door for a biometric identification—especially on a mobile device. EVM can be applied to the face as well as other body parts accessible to the front and back cameras of a smartphone.

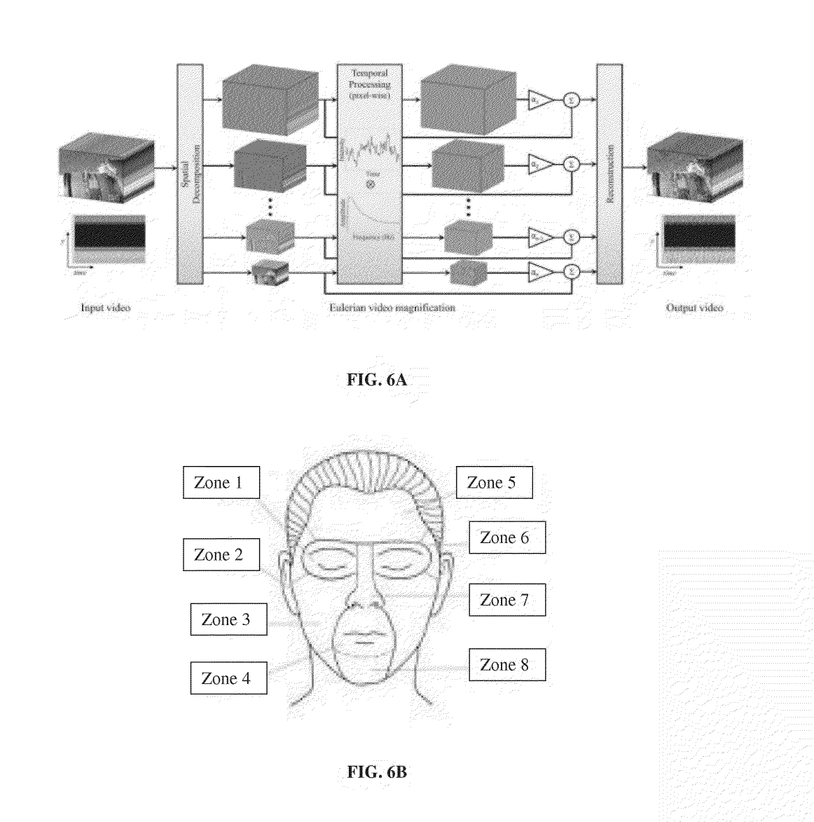

When EVM is used on faces, the face can be segmented into zones. To ensure the zones are properly marked every time the face is viewed, correction of the facial image can be performed using gaze-angle normalization previously. Once the face is normalized, individual patches can be isolated and monitored for pixel changes as the EVM algorithm is applied. The temporal sequencing of the pixel changes along with the actual changes can produce a measurable pattern that can be recorded as a template and used to ascertain identity. FIG. 6a provides a schematic overview of the EVM algorithm and FIG. 6b shows a face segmented into zones. Analysis can be performed on these zones in terms of temporal changes and variations in intensity to develop a biometric template using dynamic skin coloration as an adjunct to feature-based face identification.

EVM is not limited to enhancing face recognition. It can also be used on other body parts such as hands or can be used directly as a biometric. For instance, if a person places a finger near or over the smartphone camera, the variation in pixel color can be used to extract an EVM-based biometric.

Iris Recognition: “Traditional” iris recognition requires imagery to be captured in the near-infrared range because this frequency of light exposes features within eyes containing a high proportion of melanin—brown eyes. However, most cameras filter near-infrared light out to improve overall visual image quality. This filtering can be accomplished either in firmware or through a lens coating. To work on irises, the Identity Caddy requires the underlying smartphone have the capability of toggling its near-infrared filtering using firmware or software rather than a lens coating. Once the iris features are captured, many iris matching algorithms are available for incorporation within Identity Caddy.

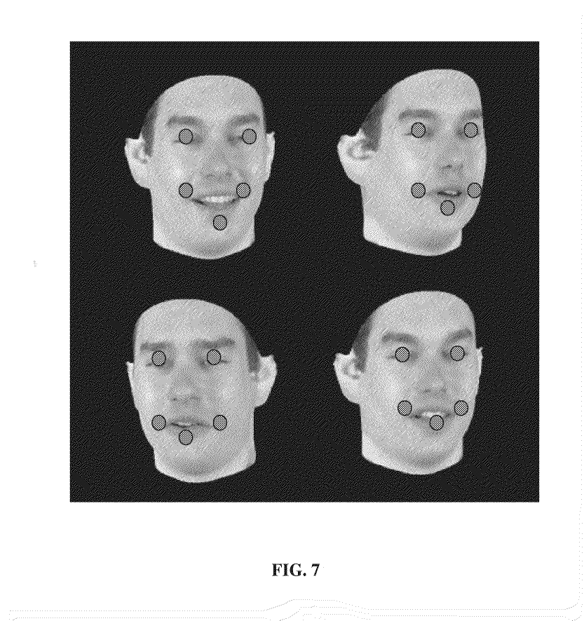

Speaker Identification: Voice biometrics technologies can provide a critical edge in capturing identity. Like other cutting edge biometric modalities, DNA, Face and Fingerprints, voice is easily collected, virtually ubiquitous, and recognized by both Law Enforcement and the Intelligence Community as an enabling technology. Core to the Identity Caddy's voice identification capability are the need to incorporate state-of-the-art acoustic-based, speaker recognition techniques developed by leading edge vendors. The Identity Caddy offers the ability to couple direct speaker recognition results with micro-features captured through other sensors. For instance, if the face is available to the camera while a person is speaking, areas of movement can be measured and correlated with speech patterns. FIG. 7 shows some of the points on the face associated with speaking. The Identity Caddy can evaluate the relationships among these points as well as the presence or disappearance of the points themselves (i.e. if the person closes an eye while speaking). The Identity Caddy can further note overall body movements—such as pacing—while a person speaks. The movement among these points—coupled with the actual speech—gives the Identity Caddy the ability to reinforce the identity results from the core speech recognition engine. Speaker identification can work in Visible and Unobtrusive modes.

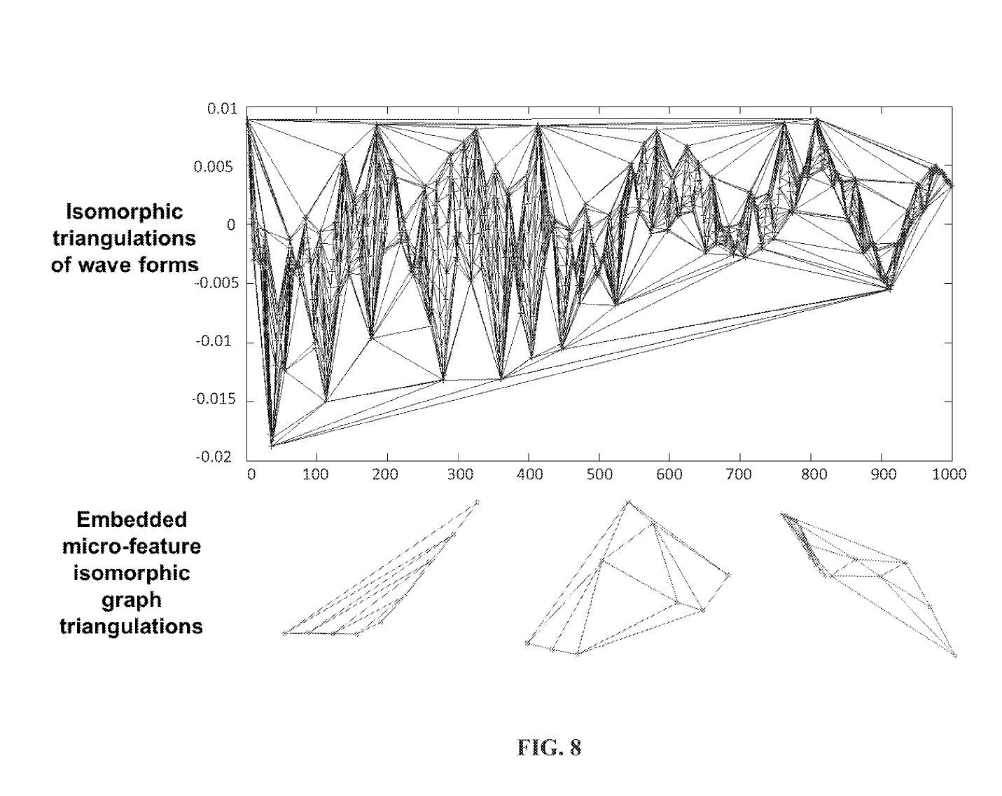

FIG. 8 shows a technique for analyzing waveforms by triangulating the raw or filtered data and calculating hash keys for embedded isomorphisms from the triangulations. This method can be incorporate within Identity Caddy to “vote” with other speaker identification engines to produce an improved result.

Gait and Motion Dynamics: These features include the patterns an individual generates while moving, other physical actions such as typing or texting as well as the micro-feature motion referenced in the previous discussion of speaker identification.

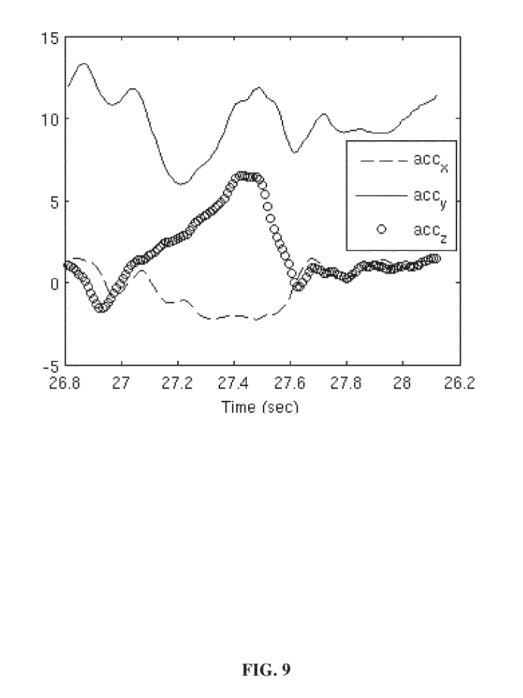

Gait is a biometric authentication method using a person's positional movements—typically while walking. Traditional gait analysis has use machine vision tools to capture movement at various points during walking. For incorporation within the Identity Caddy, gait can be obtained from the accelerometer within the smartphone. The accelerometer generates a three dimensional data stream that can be categorized in three directions: vertical, forward-backward, and sideways motion of the lower leg are obtained. The Identity Caddy uses a combination of these for individual authentication. Analysis can be applied using various methods such as histogram similarity and cycle length. FIG. 9 describes the raw data typically produced by a smartphone accelerometer. The waveform methodology presented in FIG. 8 offers one approach for analyzing gait data. However, it should be stressed that Identity Caddy is an open platform that can combine the results that are derived from commercial, open source and proprietary recognition engines.

Dynamic keystroke patters, can be used to verify or even try to determine the identity of the person who is producing those keystrokes. This is often possible because some characteristics of keystroke production are as individual as handwriting or signature.

Various measures that can be used are: (1) the rate at which a person types while texting, (2) speed by which users move between specific letters, (3) intra-character timing and overall speed for certain key words such as “the” or “and”, (4) the “hold time” (amount of time spent pressing the key) for particular letters, (5) texting abbreviations commonly used or whether the user does not use abbreviations, (6) use of capitals. Also the gyroscope can be used to assess whether the user is right or left handed which is a contributing fact toward establishing identity.

Additionally, the angle of the device—as measured through the gyroscope—and the distance to the user's face—as measured by the distance detector—provide additional insight into the user of the smartphone because these distance are related to physical characteristics and behavior patterns of the user.

Activities of daily living: These activities encompass numerous behavior patterns that contribute to identity corroboration and are discussed as follows.

Device Usage Patterns: The way a person uses the smartphone yields usage patterns of communication between the user and others. These patterns effectively present a “micro-roadmap” of common linkages. This pattern can be monitored by Identity Caddy to look for anomalies that suggest a change in identity of the user.

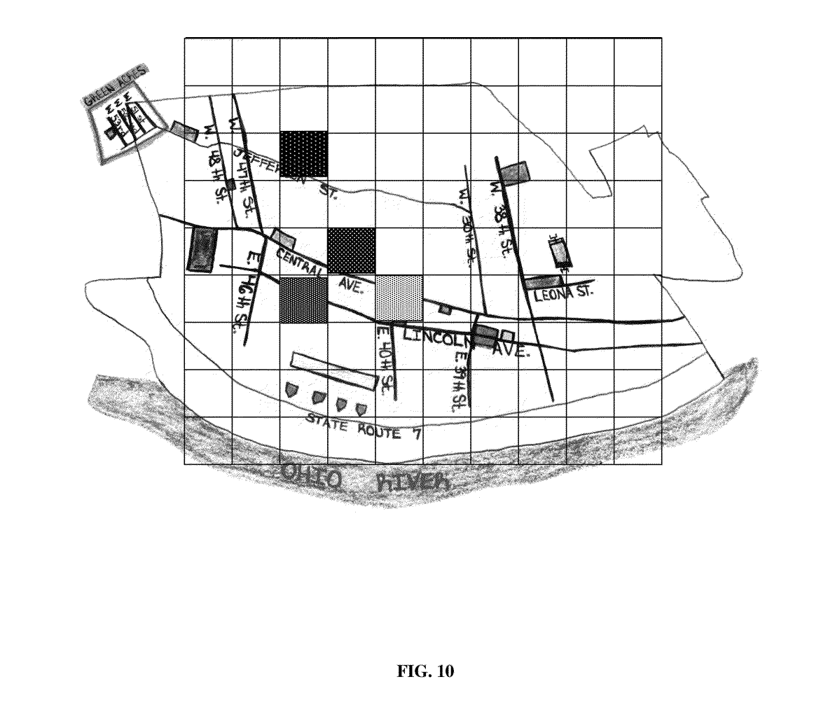

Customary Travel Patterns: Current Global Position System (“GPS”) capabilities in smartphones enable a precise compilation of travel patterns for an individual. These patterns constitute an activity of daily living and adherence to these patterns can be viewed as a means of corroborating identity. Studies have suggested that human mobility data is highly unique. Published research indicates that under the right conditions, spatio-temporal data can uniquely identify individuals with 95 percent accuracy. Patterns include paths commonly taken, places visited, duration of the visits, time of day the visit occurs, travel speed at different times and locations. These patterns of daily living can be captured through GPS as well as other methods such as the identity of WiFi networks within range. Additional data such as that provided by the accelerometer, the compass and the gyroscope can be combined with the time and geographical data. FIG. 10 shows a sample map where certain sectors have been shaded in darkening dot patterns. These patterns can be associated with the likelihood a person will be at those locations, given a particular time of day. Other forms of spatial-temporal analysis can include sequence of travel between locations, time spent at the locations, networks within range at any particular time and the like.

Using the Identity Caddy, the mobile device can constantly corroborate the person possessing it. The result takes the form of a “score” produced through the fusion of the various inputs. The score will be a scalar value that provides a measure of “Identity Assurance” similar to the way a FICO score predicts creditworthiness. devices. Identity Caddy draws upon all the sensor capability by a modern smartphone.

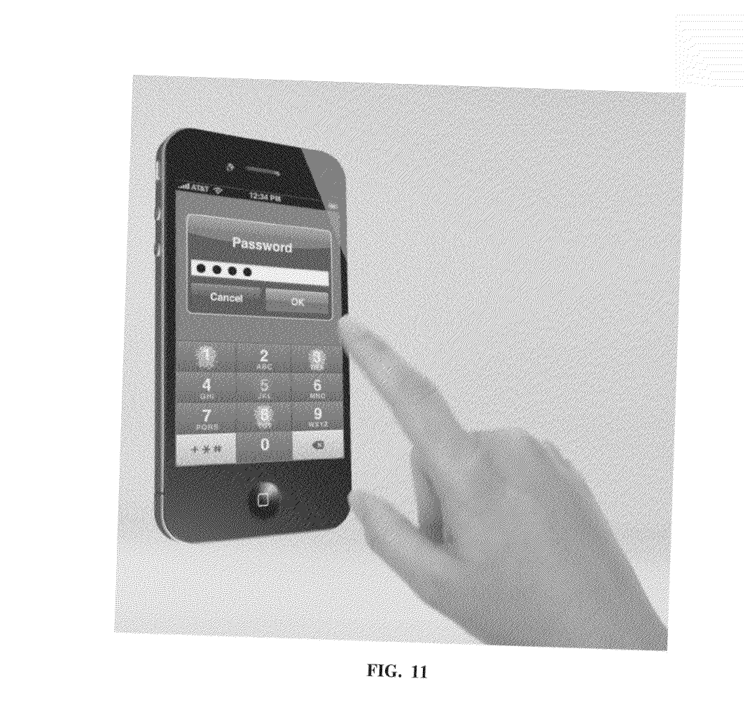

FIGS. 11-13 illustrate three examples of biometric functionality within the Identity Caddy that utilize existing sensors.

FIG. 11 illustrates how fingerprints can be automatically sensed and identified from either camera or touch display input during routine usage of a mobile device. For best performance the Identity Caddy incorporates a fingerprint matching algorithm that works with ridge flow rather than minutiae and can identify the tip and sides of the finger as well as “traditional” print impressions. Because it is not reliant on minutiae, fingerprint identification can be performed with sensor resolution as low as 160 dpi. This resolution is within the range of capabilities of many commercial cameras and at some point will be possible through resistive, capacitive or optical sensors incorporated within the touch display itself. In all cases, the Identity Caddy captures fingerprint information without altering the manner in which the user interacts with the mobile device. The fingerprint may be captured in conjunction with a passcode or it may be captured during other forms of interaction such as swiping the touch screen, keying in a phone number or touching an icon.

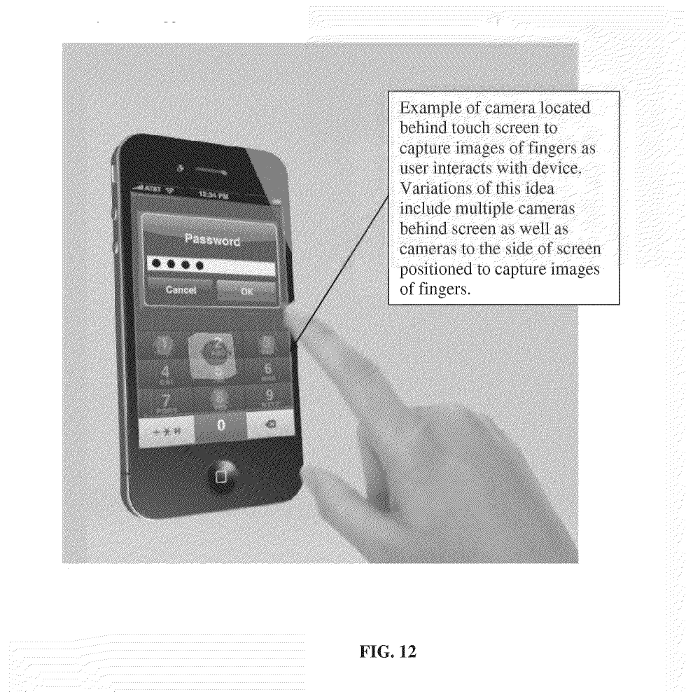

FIG. 12 illustrates the concept of a camera positioned behind the touch screen. In this implementation, the camera becomes the means for capturing fingerprint information. Alternate versions of this approach entail one or multiple cameras placed so that they view the hand as a user interacts with the device.

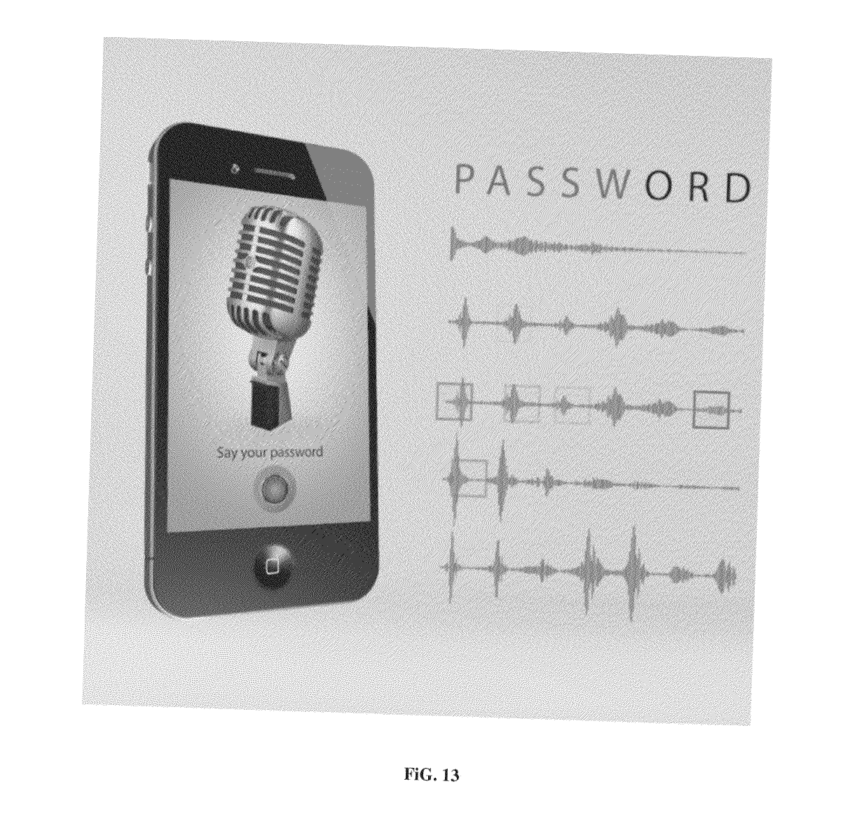

FIG. 13 shows the Identity Caddy corroborating identity through speaker identification. Using the built-in microphone found in all smartphones and virtually all other mobile devices, the Identity Caddy can establish identity from the user's voice without the need for prescribed script. For further protection, speaker identity can be established either in conjunction with a passcode but it can also be determined during routine usage of the device. The methods incorporated in the Identity Caddy do not require usage of prescribed words. As people continue to interact with their devices using voice commands such as Apple's SIRI feature, the device will have an ongoing source for both reference data and real-time monitoring of speaker identity.

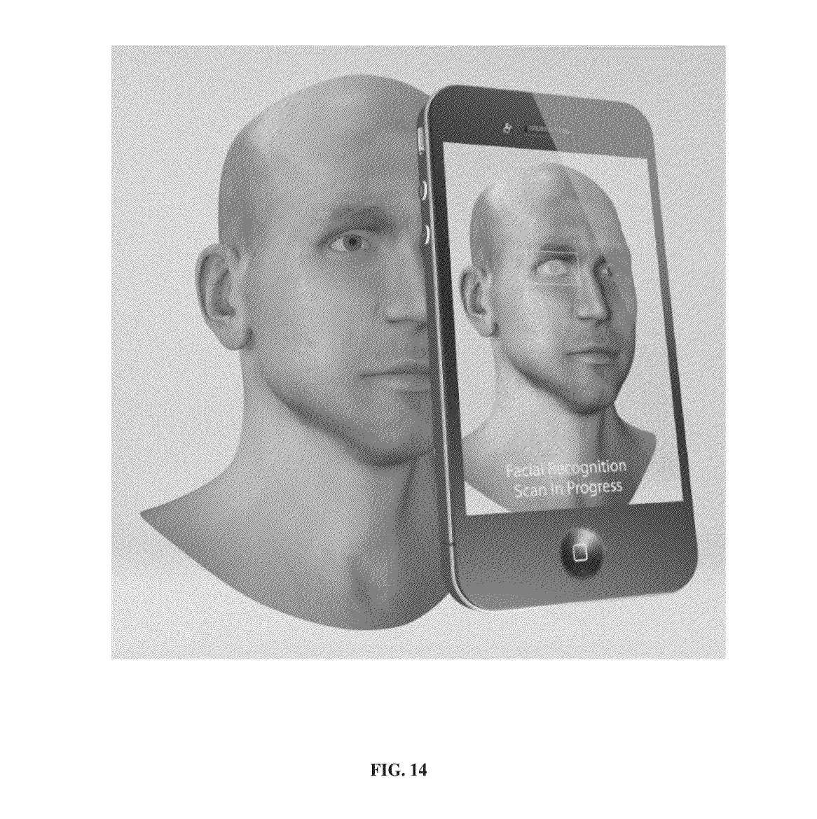

FIG. 14 shows the Identity Caddy establishing identity using facial features. It is important to note that facial features can be used for identification both individually and collectively. The Identity Caddy focuses on individual facial landmarks such as the eyes and surrounding area or the shape of the ear as well combinations of these features. Identification through facial features can occur through several methods. The camera in the mobile device can capture a direct facial “portrait” image as the user views the screen. The camera can also obtain facial “artifacts” such as ear contour as the mobile device is used as a telephone. The distance sensor, gyroscope and other features can be employed by the Identity Caddy to determine the most appropriate time to capture certain facial features. For instance, if the phone has been activated and the motion and distance sensors detect the individual is answering a call, the Identity Caddy can use the camera to capture a facial profile or finer details such as ear shape and contours.

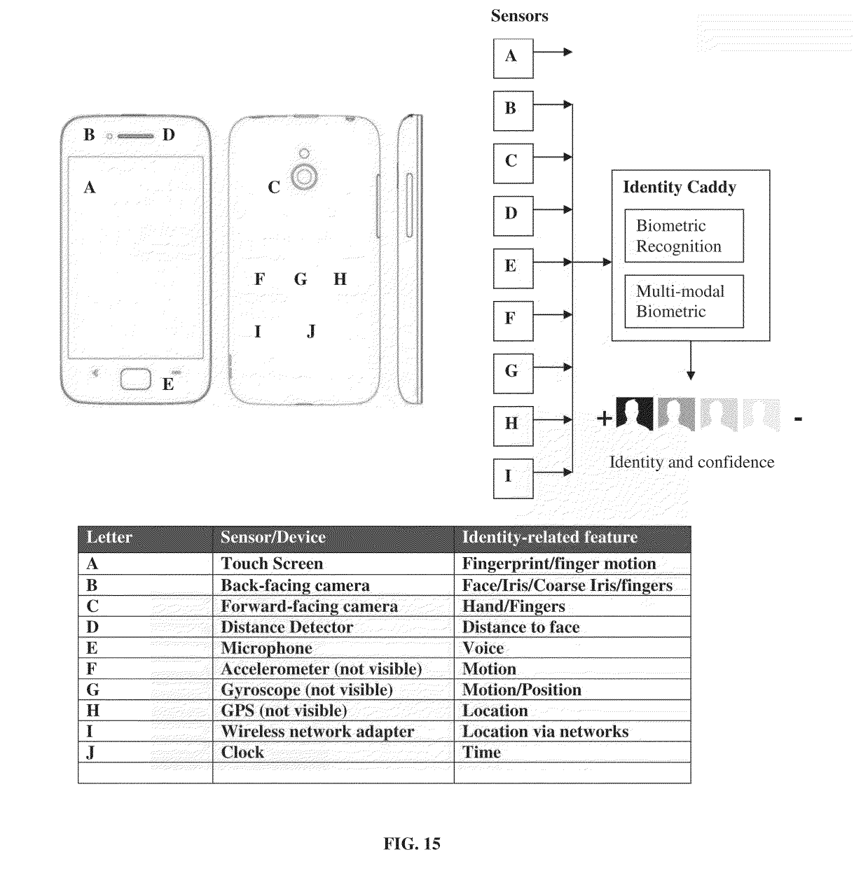

FIG. 15 shows a schematic smartphone identifying several sensors and related devices. Each of these provides input to the Identity Caddy which considers all the sensor information in concert and combines biometric information with other behavioral information such as location. Some sensors such as the touch screen (fingerprints), camera (face/fingerprints/body geometry), accelerometer (gait and location) and microphone (voice) can be used to capture biometric features. Other sensors such as GPS, clock and wireless network adaptor can be used to geo-locate the user as additional information in support of identity.

The Identity Caddy incorporates two functional modules: (1) biometric recognition and (2) biometric fusion. Biometric recognition is performed by algorithms that receive sensor input and return results in the form of personal identity. For instance, an image of a fingerprint or a face will return an identity of a person. Since the data coming from sensors will vary, each biometric recognizer returns a confidence assessment for each recognition it performs. Factors that may affect the confidence score are image quality (i.e. due to variation in lighting), views of an individual different from those previously seen, actual changes in appearance of the individual (such as wearing glasses), and the like.

The biometric fusion capability in the Identity Caddy receives the biometric recognition information and evaluates it across all biometric information provided as well as contextual information provided by non-biometric sources of information such as GPS, clock and wireless adapter. The combination of biometric and non-biometric factors is evaluated through fusion with the result being an empirical evaluation of identity.

The Identity Caddy performs multiple functions. The primary function of the Identity Caddy is to maintain an ongoing assessment of identity without expressly seeking input from the device user. This second feature encompasses using the sensors available on the device to corroborate identity under two scenarios.

The first scenario involves the role of the Identity Caddy in providing an ongoing assessment regarding the risk associated with accepting the identity claimed by the user of the device.

The second scenario entails using the Identity Caddy to corroborate identity for an online transaction performed on another device.

Regarding the first scenario, the Identity Caddy would prompt the user for information in some form. The exact nature of this request needs to be determined but the notion is that it would be unobtrusive to the user. For instance, a screen message could be displayed and a facial image could be captured from the user when reviewing the message. The objective would be to capture some form of biometric information on a directed basis that could provide sufficient comfort that the holder of the device is the actual person identified.

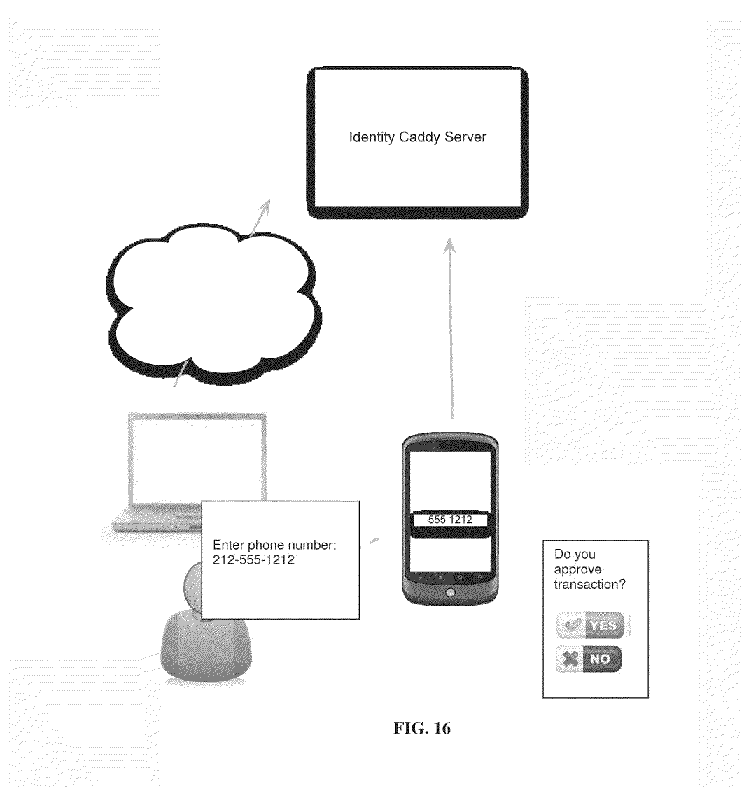

The second scenario would support the use of a device as a means of confirming identity for an online transaction performed on another device. One possible way this scenario could unfold is described as follows and is illustrated in FIG. 16.

In this scenario, a person is making an online purchase from a home computer. During the purchase, the user provides to the web site a simple form of identification such as a telephone number. The web site sends this number to a web-based verification service that associates the number with an instance of the Identity Caddy on a particular device. The web service checks the status of user verification on the device based on the fingerprint biometric that was captured the last time the user swiped the screen to unlock the device as well as other biometric information captured by the ID Caddy. If this authentication is current, the ID Caddy sends a message to the device for the user to approve the transaction. If the swipe print cannot be verified and there exists no other current identification data, the ID Caddy will prompt the user for some action that requires interacting with the portable device. During this interaction, ID Caddy captures a facial image and iris image from the user and this information becomes the basis for automatically identifying the user.

This authentication can be performed automatically using algorithms on the server and on the device or the device can transmit the token to the server via the Internet. In this manner, Identity Caddy provides an unobtrusive two-factor authentication. Little change is required to existing online services. There are various levels of involvement by which the user may participate in the authentication process. As described above, the user could respond to a prompt provided on the smartphone after authentication by Identity Caddy. Identity Caddy could also communicate directly with the web site either by a WIFI network connection, or it could capture an image of the home computer screen, or it could communicate with the home computer through an audio signal outside the range of human hearing.

In conjunction with the previously mentioned and similar transactions, the Identity Caddy can also perform “on the fly” biometric verification using the various sensors at its disposal. A person could be prompted to look into the camera or say some words or take other actions that would enable the Identity Caddy to capture real time biometric data from the person in possession of the device. The exact request for biometrics can be “randomized” to avoid the possibility of “spoofing” a biometric that is anticipated.

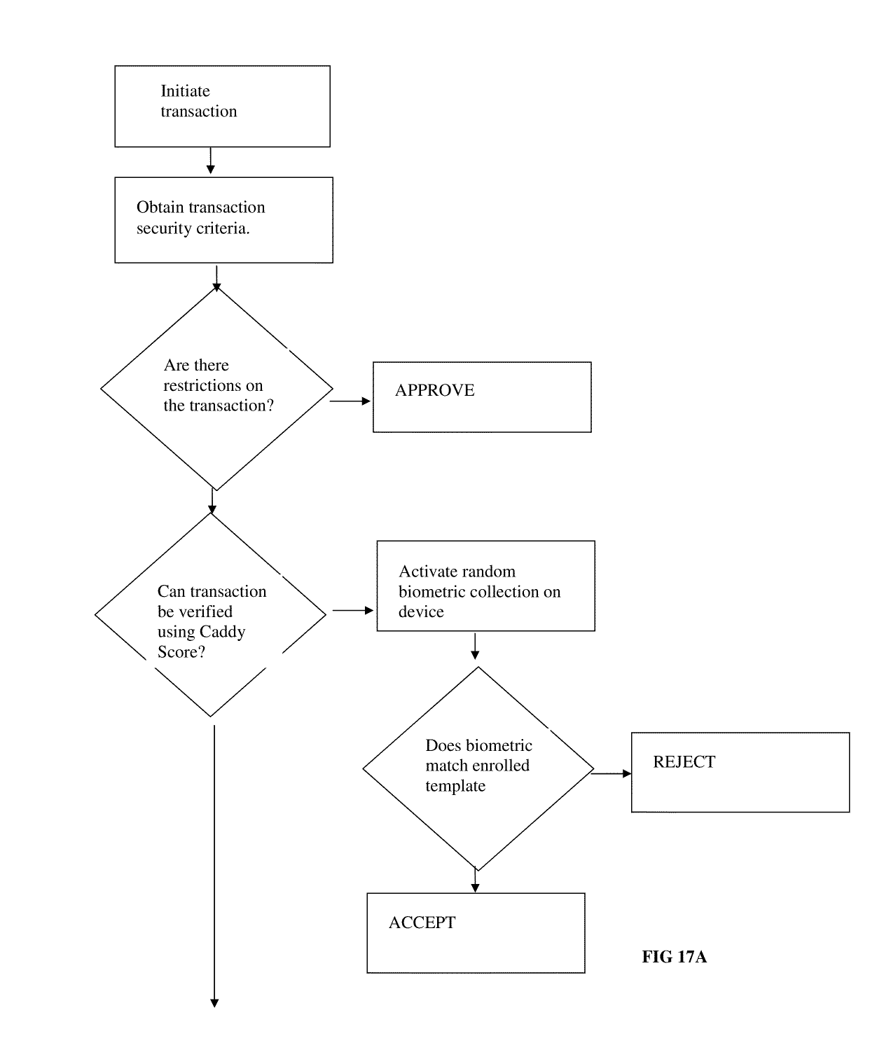

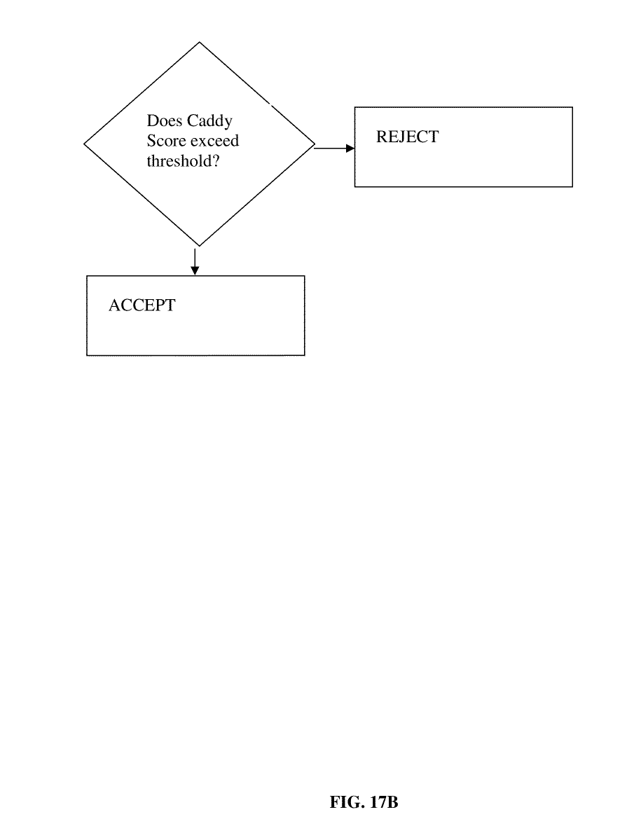

FIG. 17A shows a high level schematic flow of identity corroboration using the Identity Caddy. Once a transaction is initiated, the security criteria for the transaction are downloaded from the party with whom the transaction is being performed. For instance, it the transaction involves a purchase, the criteria will come from the merchant of vendor. If it is a financial transaction, the bank or credit card company will issue the criteria. The purpose of the security criteria is to establish the amount of protection to be placed upon the transaction.

FIG. 17B shows a following receipt of the security criteria, the first decision is to determine if the transaction is to be secured at all. If not, immediate approval can be provided and there is no need for validation by the Identity Caddy.

If the security criteria require validation, the next decision is whether the security criteria permit identity validation by the ongoing monitoring performed by the Identity Caddy or if it is necessary to capture biometric data in real time. If biometric data is required, the Identity Caddy will use one or more of its sensors to capture the data. The notion underlying the real time acquisition of biometric data is that it be “randomized” to eliminate the opportunities for spoofing that would be possible if the exact biometric were known in advance.

If real time biometric acquisition is required and the biometric measures captured match the identity to be validated. The transaction is approved. Otherwise, it is declined. This feature is important because one of the functions of the Identity Caddy is to perform as a mobile identity corroboration device in support of transactions taking place on other devices such as computers, ATMs, kiosks and the like.

Finally, if the security criteria for the transaction will accept the identity assessment generated by the Identity Caddy, the threshold associated with the security criteria is compared with the assessment score generated by the Identity Caddy. As previously discussed, the precise computation of this score can be proprietary to the party sponsoring the transaction (bank, credit card company, merchant, etc.). If the Identity Caddy's assessment score exceeds the threshold specified in the security criteria, the transaction is approved.

If the Identity Caddy's assessment score falls below the threshold, there are two options: (1) decline the transaction or (2) ask for a real-time biometric sample. If the second choice is specified in the security criteria, the Identity Caddy will request specific biometric data. These data will then be compared with enrolled samples from the individual being validated and if matched, the transaction will be approved. Otherwise, it will be declined.

What is claimed is:

1. A mobile device, comprising:
one or more biometric sensors configured to generate at least one biometric reading;
one or more non-biometric sensors configured to generate at least one non-biometric reading; and
a processor coupled with the one or more biometric sensors and the one or more non-biometric sensors, the processor configured to
constantly monitor the readings generated by the biometric and non-biometric sensors,
verify the identity of a user of the mobile device, based on a combination of the biometric and non-biometric readings,
continuously determine behavior information for the user based on the readings, and
update the verification or a degree of certainty associated with the verification of the identity of the user based on the behavior information.

2. The mobile device of claim 1, wherein the biometric sensors include at least one of a digital camera, a microphone, a touch display sensor, and a fingerprint scanner.

3. The mobile device of claim 1, wherein the non-biometric sensors include at least one of an accelerometer, a gyroscope, a distance detector, a GPS, a clock, a compass, and a network connectivity detector.

4. The mobile device of claim 1, wherein the processor is configured to generate biometric measures based on the biometric readings, and use the biometric measures to verify the identity of the user.

5. The mobile device of claim 4, wherein the biometric measures include at least one of a fingerprint, a face, facial features, a skin coloration, an iris recognition, a speaker identification, a gait, and motion dynamics.

6. The mobile device of claim 1, wherein the processor is configured to fuse the readings in order to generate a degree of certainty of the identity of the user.

7. The mobile device of claim 6, wherein a degree of certainty is generated for at least one of the following categories: physical characteristics, physical expression, and activity pattern.
